(19) United States
(12) Patent Application Publication
(10) Pub. No.: US 2021/0383093 A1
(43) Pub. Date: Dec. 9, 2021

(54) METHOD FOR DETERMINING SAG OF ELECTRICITY TRANSMISSION LINE BASED ON IMAGE RECOGNITION

(71) Applicant: STATE GRID ZHEJIANG ELECTRIC POWER CO., LTD. CONSTRUCTION BRANCH, Hangzhou (CN)

(72) Inventors: Yaoming YAO, Hangzhou (CN); Gang CHEN, Hangzhou (CN); Zhe CHEN, Hangzhou (CN); Liwei ZHENG, Hangzhou (CN); Ti LIU, Hangzhou (CN); Pengcheng CUI, Hangzhou (CN); Zhen WU, Hangzhou (CN); Gong ZHANG, Hangzhou (CN); Hongwei MAO, Hangzhou (CN); Qi YUAN, Hangzhou (CN)

(73) Assignee: STATE GRID ZHEJIANG ELECTRIC POWER CO., LTD. CONSTRUCTION BRANCH, Hangzhou (CN)

(21) Appl. No.: 17/336,336

(22) Filed: Jun. 2, 2021

(30) Foreign Application Priority Data
Jun. 3, 2020 (CN) 202010494477.5

(51) Int. Cl. G06K 9/00; G06T 7/70; G06T 11/20; G06K 9/46; G06T 7/50; B64C 39/02; G05D 1/00

(52) U.S. Cl. CPC G06K 9/0063; G06T 7/70; G06K 9/00664; G06T 11/203; G05D 2201/0207; G06T 7/50; B64C 39/024; G05D 1/0094; B64C 2201/127; G06K 9/4652

(57) ABSTRACT

A method for determining sag of an electricity transmission line based on image recognition is provided. In the method, an image of an electricity transmission line in a target area captured by an unmanned aerial vehicle is acquired and coordinates of a catenary corresponding to the electricity transmission line is extracted from the image. A catenary curve equation is constructed based on the extracted coordinates of the catenary and a complete catenary curve is drawn according to the catenary curve equation. A sag expression of the catenary is obtained based on the complete catenary curve and the catenary curve equation. A derivative of the sag expression is calculated to obtain a maximum sag.

The present application claims priority to Chinese Patent Application No. 202010494477.5, titled “METHOD FOR DETERMINING SAG OF ELECTRICITY TRANSMISSION LINE BASED ON IMAGE RECOGNITION”, filed on Jun. 3, 2020 with the China National Intellectual Property Administration, which is incorporated herein by reference in its entirety

### FIELD

The present disclosure relates to the field of transmission line maintenance, and in particular to a method for determining sag of an electricity transmission line based on image recognition.

### BACKGROUND

Sag of an electricity transmission line is one of main indexes in design, operation and maintenance of electricity transmission lines. If the sag is small, a tensile stress of the overhead line is large and thus the load on a tower supporting the line is large, which is not safe and may even result in accidents such as line break, tower fall and string drop. If the sag is large, a distance between the overhead line and the ground or any objects across the overhead line is insufficient for safety, causing a risk of power outage caused by the line swing, waving or jumping with wind. Therefore, it is required to monitor the sag in a real time manner in daily inspection of the operating lines to control the sag to be in a required range, so as to ensure safety of the electricity transmission line and devices across the electricity transmission line.

The conventional methods for measuring or calculating sag of an electricity transmission line include an angle method, a sag plate observation method, a midpoint height method and the like. However, the above methods all have problems of high difficulty, poor real-time performance, or large error.

### SUMMARY

In order to solve the above problem in the conventional technologies, a method for determining sag of an electricity transmission line based on image recognition is provided according to the present disclosure. A vertical angle and a horizontal angle in a theodolite are automatically recognized by taking a photograph, and the sag is directly calculated according to a sag calculation formula, which effectively improves accuracy of sag calculation.

The method for determining sag of an electricity transmission line based on image recognition is provided according to the present disclosure, which includes: acquiring an image of an electricity transmission line in a target area captured by an unmanned aerial vehicle and extracting coordinates of a catenary corresponding to the electricity transmission line from the image; constructing a catenary curve equation based on the extracted coordinates of the catenary and drawing a complete catenary curve according to the catenary curve equation; and obtaining a sag expression of the catenary based on the complete catenary curve and the catenary curve equation, and calculating a derivative of the sag expression to obtain a maximum sag.

In an embodiment, the acquiring an image of an electricity transmission line in a target area captured by an unmanned aerial vehicle and extracting coordinates of a catenary corresponding to the electricity transmission line from the image includes: controlling the unmanned aerial vehicle to go to the target area to perform aerial photography to acquire the image of the electricity transmission line; and performing image recognition on the image, extracting pixel coordinates of pixels representing the electricity transmission line from the image, and obtaining the coordinates of the catenary corresponding to the electricity transmission line based on the extracted pixel coordinates.

In an embodiment, the performing image recognition on the image, extracting pixel coordinates of pixels representing the electricity transmission line from the image, and obtaining the coordinates of the catenary corresponding to the electricity transmission line based on the extracted pixel coordinates includes: extracting pixels representing the electricity transmission line from the image based on color and shape features of the image; establishing a two-dimensional coordinate system for the image, and determining pixel coordinates of the extracted pixels representing the electricity transmission line in the two-dimensional coordinate system; and obtaining the coordinates of the catenary corresponding to the electricity transmission line based on the pixel coordinates.

In an embodiment, the obtaining the coordinates of the catenary corresponding to the electricity transmission line based on the pixel coordinates includes: extracting pixels of an upper edge of the electricity transmission line and pixels of a lower edge of the electricity transmission line; selecting first pixels from the pixels of the upper edge of the electricity transmission line, and selecting, for each of the first pixels, a second pixel of the lower edge of the electricity transmission line which is in a same vertical line as the first pixel; calculating, for each of the first pixels, an average of the coordinates of the first pixel and the coordinates of the second pixel in the same vertical line as the first pixel; and determining averages calculated for all of the first pixels as the coordinates of the catenary corresponding to the electricity transmission line.

In an embodiment, the constructing a catenary curve equation based on the extracted coordinates of the catenary and drawing a complete catenary curve according to the catenary curve equation includes: drawing a partial catenary curve based on the obtained coordinates of the catenary, and calculating a secant of an angle between a tangent of the catenary curve at a target point and a coordinate axis; constructing an equation of the partial catenary curve including the target point by using the secant as a parameter; and drawing the complete catenary curve based on a fixed span of the electricity transmission line and coordinates of endpoints of the partial catenary curve.

In an embodiment, the catenary curve equation is expressed as the following equation (1):

$$y = ach ( \frac{x}{a} + archn - \frac{l}{a} ) - ach ( archn - \frac{l}{a} ) + {y}_{0} ,$$

where ch( ) represents a hyperbolic cosine function arch( ) represents an inverse hyperbolic cosine function, n represents the secant of the angle between the tangent of the catenary curve at the target point and a coordinate axis, that is secθ=n, (l,h) represents coordinates of the target point, and a represents a function to be solved.

In an embodiment, the drawing the complete catenary curve based on a fixed span of the electricity transmission line and coordinates of endpoints of the partial catenary curve includes: measuring a first distance between an endpoint of the electricity transmission line and a point at the electricity transmission line corresponding to an end point of the partial catenary curve, and a second distance between the endpoint of the electricity transmission line and a point at the electricity transmission line corresponding to the other end point of the partial catenary curve; performing proportional conversion on the fixed span of the electricity transmission line, the first distance and the second distance, to obtain a parameter of the complete catenary curve, and drawing the complete catenary curve based on the parameter.

In an embodiment, the obtaining a sag expression of the catenary based on the complete catenary curve and the catenary curve equation, and calculating a derivative of the sag expression to obtain a maximum sag includes: determining coordinates of two endpoints of the complete catenary curve, and constructing an equation of a straight line crossing the two endpoints; obtaining the sag expression of the catenary as the equation of the straight line minus the catenary curve equation; calculating the derivative of the sag expression to obtain the maximum sag and a pixel coordinate corresponding to the maximum sag.

In an embodiment, the method for determining sag of an electricity transmission line based on image recognition further includes: calculating errors between coordinates of pixels obtained by the sage expression and coordinates of corresponding pixels in the image; calculating an average error rate from the calculated errors; and modifying the obtained maximum sag based on the average error rate.

Beneficial effects of the technical solutions according to the present disclosure are described as following. Image recognition is performed on the image captured by the unmanned aerial vehicle, and thus a catenary curve is drawn based on a result of the image recognition to obtain the equation of the catenary corresponding to the electricity transmission line, thereby obtaining the sag expression. Finally, the maximum sag is calculated by calculating a derivative. Compared with the conventional method for calculating sag, the method according to the present disclosure, which combines image processing with catenary calculation, can effectively improve accuracy of sag calculation.

### BRIEF DESCRIPTION OF THE DRAWINGS

In order to clearly describe the technical solutions in the embodiments of the present disclosure, drawings to be used in the description of the embodiments are briefly described hereinafter. It is apparent that the drawings described below show merely some embodiments of the present disclosure. Those skilled in the art may obtain other drawings according to the provided drawings without any creative effort.

FIG. 1 is a flowchart of a method for determining sag of an electricity transmission line based on image recognition according to an embodiment of the present disclosure;

FIG. 2 is a schematic diagram showing the extraction of a parameter of the line according to an embodiment of the present disclosure; and

FIG. 3 is a schematic diagram showing the measured data according to an embodiment of the present disclosure.

### DETAILED DESCRIPTION OF EMBODIMENTS

In order to make the technical solutions and advantages of the present disclosure clear, the technical solutions of the present disclosure are described below in conjunction with the drawings.

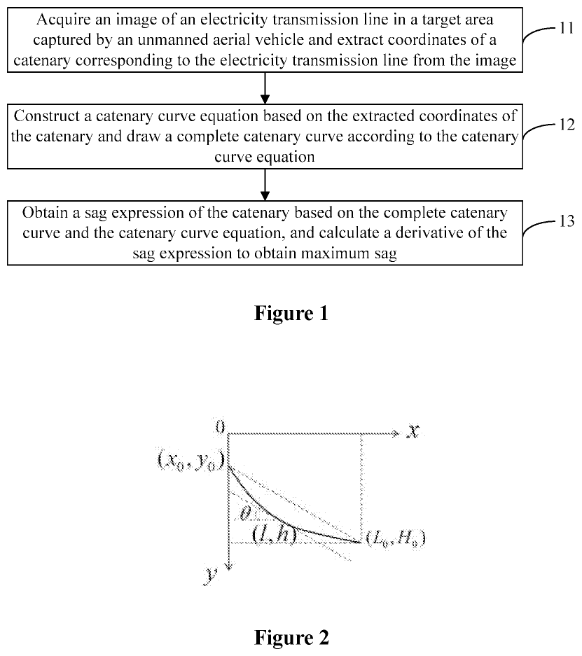

A method for determining sag of an electricity transmission line based on image recognition according to an embodiment of the present disclosure is as shown in FIG. 1. The method includes the following steps 11 to 13.

In step 11, an image of an electricity transmission line in a target area captured by an unmanned aerial vehicle is acquired and coordinates of a catenary corresponding to the electricity transmission line are extracted from the image.

In step 12, a catenary curve equation is constructed based on the extracted coordinates of the catenary, and a complete catenary curve is drawn according to the catenary curve equation.

In step 13, a sag expression of the catenary is obtained based on the complete catenary curve and the catenary curve equation, and a derivative of the sag expression is calculated to obtain a maximum sag.

In the embodiment, the method for determining sag of an electricity transmission line based on image recognition according to the present disclosure mainly includes two stages. In the first stage, image recognition is performed on the image captured by the unmanned aerial vehicle and pixel coordinates corresponding to the electricity transmission line are extracted. In the second stage, the catenary curve equation is constructed based on the extracted pixel coordinates, and then the sag expression is obtained based on the constructed equation. In the present disclosure, image recognition is performed on the image captured by the unmanned aerial vehicle, and then a catenary curve is drawn based on a result of the image recognition to obtain the equation of the catenary corresponding to the electricity transmission line, thereby obtaining the sag expression. Finally, the maximum sag is calculated by performing derivation on the sage expression. Compared with the conventional method for calculating sag, the method according to the present disclosure, which combines image processing with catenary calculation, can effectively improve accuracy of sag calculation.

Step 11 includes the following steps 111 and 112.

In step 111, the unmanned aerial vehicle is controlled to go to the target area to perform aerial photography to acquire the image of the electricity transmission line.

In step 112, image recognition is performed on the image, and pixel coordinates of pixels representing the electricity transmission line are extracted from the image. The extracted pixel coordinates are used to obtain coordinates of the catenary corresponding to the electricity transmission line.

In the embodiment, the image of the electricity transmission line is first acquired for calculating the sag of the electricity transmission line. The image in the embodiment of the present disclosure is captured by the unmanned aerial vehicle. After the image is acquired, image recognition is performed on the image to extract a partial image having features of the electricity transmission line, and pixel coordinates of each pixel included in the partial image is calculated in the coordinate system defined for the image. Finally, the obtained pixel coordinates are used to obtain coordinates of the catenary in a form of an array.

A catenary refers to a curve formed by a uniform (in thickness and mass distribution) and soft (but cannot be stretched) chain with two fixed ends under action of gravity, like a suspension bridge. The above curve is similar to a curve formed by a rope fixed at two ends and dropping under action of uniform gravity. In an appropriately selected coordinate system, an equation of the catenary is a hyperbolic cosine function. In order for convenience of description of the subsequent derivation and operation process, hereinafter the catenary is used for referring to the electricity transmission line.

A process of obtaining the coordinates of the catenary in step 112 includes the following steps 1121 to 1123.

In step 1121, pixels representing the electricity transmission line are extracted from the image based on color and shape features of the image.

In step 1122, a two-dimensional coordinate system is established for the image, and pixel coordinates of the pixels representing the electricity transmission line are determined in the two-dimensional coordinate system.

In step 1123, coordinates of the catenary corresponding to the electricity transmission line are determined based on the pixel coordinates.

In order to reduce the amount of data used in subsequent mathematical calculations, the obtained pixels are filtered herein. The following steps 1) to 4) are optimally performed on the pixel coordinates in step 1123.

In step 1), pixels of an upper edge of the electricity transmission line and pixels of a lower edge of the electricity transmission line are determined.

In step 2), first pixels are selected from the pixels of the upper edge of the electricity transmission line, and for each of the first pixels, a second pixel of the lower edge of the electricity transmission line, which is in a same vertical line as the first pixel, is selected.

In step 3), for each of the first pixels, an average of the coordinates of the first pixel and the coordinates of the second pixel in the same vertical line as the first pixel, is calculated.

In step 4), the averages calculated for all of the first pixels are determined as the coordinates of the catenary corresponding to the electricity transmission line.

In the embodiment, two edges of the electricity transmission line in the image may be obtained through edge detection. For curve smoothing, a middle line between the two edges may be used for representing the catenary, so as to accurately reflect the hanging state of the electricity transmission line.

In determining a middle point, if there are n pixels having the same x-coordinate, a y-coordinate of the middle point may be expressed as

$$y = \frac{1}{n} {\sum }_{i = 1}^{n} {y}_{i} ,$$

where yᵢ represents a y-coordinate of the i-th pixel.

Step 12 includes the following steps 121 to 123.

In step 121, a partial catenary curve is drawn based on the obtained coordinates of the catenary, and a secant of an angle between a tangent of the catenary curve at a target point and a coordinate axis is calculated.

In step 122, an equation of the catenary curve including the target point is constructed by using the secant as a parameter.

The catenary curve equation is expressed as the following equation (1):

$$y = ach ( \frac{x}{a} + archn - \frac{l}{a} ) - ach ( archn - \frac{l}{a} ) + {y}_{0} \qquad equation ( 1 )$$

In the above equation (1), ch( ) represents a hyperbolic cosine function, represents an inverse hyperbolic cosine function, n represents the secant of the angle between the tangent of the catenary curve at the target point and a coordinate axis, that is, secθ=n, (l,h) represents coordinates of the target point, and a represents a function to be solved.

As shown in FIG. 2, sag of the overhead line is calculated using a catenary model.

Based on the idea of analyzing a flexible cable structure with a “catenary segment” method, the following idea of calculating sag based on image processing is provided.

For a fixed span, only one independent variable is required to determine the sag of the electricity transmission line. By determining the independent variable, a complete catenary curve can be restored and the sag of the complete catenary curve can be calculated.

FIG. 2 is a schematic diagram showing the determination of the parameter of a catenary segment. Using the Coordinate system defined in the digital image processing, the secant of an inclination angle at the vertex of the catenary curve is selected as an independent variable to solve the catenary curve. Assuming that secθ=n where θ represents the inclination angle at the vertex of the catenary curve, the hanging state of the catenary can be determined from equation (1).

In step 123, the complete catenary curve is drawn based on the fixed span of the electricity transmission line and coordinates of endpoints of the partial catenary curve.

In the embodiment, a first distance and a second distance are measured, where the first distance is a distance between an endpoint of the electricity transmission line and a point at the electricity transmission line corresponding to an end point of the partial catenary curve, and the second distance is a distance between the endpoint of the electricity transmission line and a point at the electricity transmission line corresponding to the other end point of the partial catenary curve.

A parameter of the complete catenary curve in the image is obtained by performing proportional conversion on the fixed span of the catenary, the first distance and the second distance, and the complete catenary curve is drawn based on the parameter.

A process of determining the parameter includes the following steps (1) to (4).

In step (1), coordinates (x₀, y₀) and (L₀, H₀) of two endpoints of the catenary segment in the image are acquired, and a slope k of a straight line connecting the two endpoints is calculated to obtain an equation of the straight line connecting the two endpoints.

In step (2), a maximum distance between the catenary segment and the straight line is calculated according to the formula for calculating a distance between a point and a straight line, and the point corresponding to the maximum distance serves as a tangent point. Coordinates of the tangent point are expressed as (l, h).

In step (3), a tangent tan θ of the inclination angle at the vertex of the catenary curve is equal to k, that is, n=1/k, where coordinates of the tangent point are the coordinates (l, h) of the vertex.

In step (4), a is solved according to

$$\frac{h}{a} = n - ch ( archn - \frac{1}{a} ) ,$$

and thus the equation of the catenary is determined.

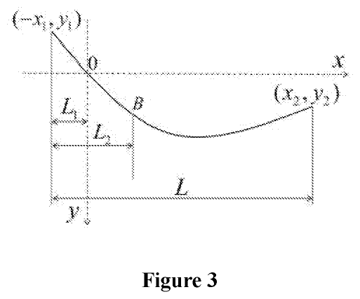

The catenary segment in the image is extended according to the obtained equation (2) to restore the complete catenary curve. The complete catenary curve can be restored by calculating the abscissas of two endpoints of the complete catenary curve. Calculation of the abscissas is as shown in FIG. 3.

FIG. 3 is a schematic diagram showing the measured data. A segment OB (a coordinate system is established with a point O as an origin) corresponds to a captured electricity transmission line segment. L represents the fixed span. L₁ represents a horizontal distance between an end of the captured electricity transmission line segment and an endpoint of the catenary, and L₂ represents a horizontal distance between the other end of the captured electricity transmission line segment and the endpoint of the catenary. Values of L, L₁ and L₂ are obtained through measurement. Definition of L₀ in the following equations is as shown in FIG. 2. L₀ represents an abscissa of an endpoint of the catenary segment.

$${x}_{1} = {L}_{1} \times \frac{{L}_{0}}{{L}_{2} - {L}_{1}} , {x}_{2} = {L}_{2} \times \frac{{L}_{0}}{{L}_{2} - {L}_{1}}$$

A curve in an interval from −x₁ to x₂ is drawn by taking the origin of the catenary curve segment as the origin to obtain the complete catenary curve in the span.

Step 31 includes the following steps 131 to 133.

In step 131, coordinates of two endpoints of the complete catenary curve are determined, and an equation of a straight line crossing the two endpoints is constructed.

In step 132, the sag expression of the catenary is obtained as the equation of the straight line minus the catenary curve equation.

In step 133, a derivative of the sag expression is calculated to obtain the maximum sag and pixel coordinates corresponding to the maximum sag.

In the embodiment, coordinates (−x₁, y₁) and (x₂, y₂) of the two endpoints of the complete catenary restored in the previous step are determined, such that an equation of the straight line connecting the two endpoints of the complete catenary is expressed as

$${y}_{d} = \frac{{y}_{2} - {y}_{1}}{{x}_{2} - {x}_{1}} \times ( x + {x}_{1} ) + {y}_{2} .$$

By subtracting the equation (1) from the equation of the straight line to obtain the sag of the catenary as:

$$f = {y}_{d} - ach ( \frac{x}{a} + archn - \frac{1}{a} ) + ach ( archn - \frac{1}{a} ) - {y}_{0} .$$

The maximum sag fₘₐₓ is obtained by substituting x=a(arshk1−archn)+1 into the above equation, where

$${k}_{1} = \frac{{y}_{2} - {y}_{1}}{{x}_{2} - {x}_{1}} .$$

In an embodiment, the method for determining sag of an electricity transmission line based on image recognition further includes the following steps 141 to 143.

In step 141, errors between coordinates pixels obtained by the sage expression and coordinates of corresponding pixels in the image are calculated.

In step 142, an average error rate is calculated from the calculated errors.

In step 143, the obtained maximum sag is modified based on the average error rate.

In the embodiment, a relative error between a coordinate of a restored pixel and a pixel that is in the image and corresponds to the restored pixel is expressed as

$$α = \frac{y - {y}^{′}}{y} ,$$

and the average error rate is expressed as

$$\overline{α} = \frac{1}{n} {Σ}_{n} α ,$$

where y represents a coordinate of a pixel in the image and y′ represents a coordinate of a restored pixel corresponding to the pixel in the image.

A relative error between sag obtained through calculation and sag obtained through actual measurement is expressed as

$$β = \frac{f - f max}{f} ,$$

where f represents the sag obtained through actual measurement, and fₘₐₓ represents the sag obtained through calculation.

The serial numbers in the above embodiments are only for description and do not represent an order in assembling or using components.

The above are merely embodiments of the present disclosure and are not intended to limit the present disclosure. Any modifications, equivalent substitutions and improvements made within the spirit and the principle of the present disclosure fall within the protection scope of the present disclosure.

1. A method for determining sag of an electricity transmission line based on image recognition, comprising:
acquiring an image of an electricity transmission line in a target area captured by an unmanned aerial vehicle and extracting coordinates of a catenary corresponding to the electricity transmission line from the image;
constructing a catenary curve equation based on the extracted coordinates of the catenary, and drawing a complete catenary curve according to the catenary curve equation; and
obtaining a sag expression of the catenary based on the complete catenary curve and the catenary curve equation and calculating a derivative of the sag expression to obtain a maximum sag.

2. The method for determining sag of an electricity transmission line based on image recognition according to claim 1, wherein the acquiring an image of an electricity transmission line in a target area captured by an unmanned aerial vehicle and extracting coordinates of a catenary corresponding to the electricity transmission line from the image comprises:
controlling the unmanned aerial vehicle to go to the target area to perform aerial photography to acquire the image of the electricity transmission line; and
performing image recognition on the image, extracting pixel coordinates of pixels representing the electricity transmission line from the image, and obtaining the coordinates of the catenary corresponding to the electricity transmission line based on the extracted pixel coordinates.

3. The method for determining sag of an electricity transmission line based on image recognition according to claim 2, wherein the performing image recognition on the image, extracting pixel coordinates of pixels representing the electricity transmission line from the image, and obtaining the coordinates of the catenary corresponding to the electricity transmission line based on the extracted pixel coordinates comprises:
extracting pixels representing the electricity transmission line from the image based on color and shape features of the image;
establishing a two-dimensional coordinate system for the image, and determining pixel coordinates of the extracted pixels representing the electricity transmission line in the two-dimensional coordinate system; and
obtaining the coordinates of the catenary corresponding to the electricity transmission line based on the pixel coordinates.

4. The method for determining sag of an electricity transmission line based on image recognition according to claim 3, wherein the obtaining the coordinates of the catenary corresponding to the electricity transmission line based on the pixel coordinates comprises:
extracting pixels of an upper edge of the electricity transmission line and pixels of a lower edge of the electricity transmission line;
selecting first pixels from the pixels of the upper edge of the electricity transmission line, and selecting, for each of the first pixels, a second pixel of the lower edge of the electricity transmission line which is in a same vertical line as the first pixel;
calculating, for each of the first pixels, an average of the coordinates of the first pixel and the coordinates of the second pixel in the same vertical line as the first pixel; and
determining averages calculated for all of the first pixels as the coordinates of the catenary corresponding to the electricity transmission line.

5. The method for determining sag of an electricity transmission line based on image recognition according to claim 1, wherein the constructing a catenary curve equation based on the extracted coordinates of the catenary and drawing a complete catenary curve according to the catenary curve equation comprises:
drawing a partial catenary curve based on the obtained coordinates of the catenary, and calculating a secant of an angle between a tangent of the catenary curve at a target point and a coordinate axis;
constructing an equation of the partial catenary curve including the target point by using the secant as a parameter; and
drawing the complete catenary curve based on a fixed span of the electricity transmission line and coordinates of endpoints of the partial catenary curve.

6. The method for determining sag of an electricity transmission line based on image recognition according to claim 5, wherein the catenary curve equation is expressed as
$$y = ach ( \frac{x}{a} + archn - \frac{l}{a} ) - ach ( archn - \frac{l}{a} ) + {y}_{0} ,$$
wherein ch( ) represents a hyperbolic cosine function, arch( ) represents an inverse hyperbolic cosine function, n represents the secant of the angle between the tangent of the catenary curve at the target point and a coordinate axis, that is secθ=n, (l,h) represents coordinates of the target point, and a represents a function to be solved.

7. The method for determining sag of an electricity transmission line based on image recognition according to claim 5, wherein the drawing the complete catenary curve based on a fixed span of the electricity transmission line and coordinates of endpoints of the partial catenary curve comprises:
measuring a first distance between an endpoint of the electricity transmission line and a point at the electricity transmission line corresponding to an end point of the partial catenary curve, and a second distance between the endpoint of the electricity transmission line and a point at the electricity transmission line corresponding to the other end point of the partial catenary curve;
performing proportional conversion on the fixed span of the electricity transmission line, the first distance and the second distance, to obtain a parameter of the complete catenary curve, and
drawing the complete catenary curve based on the parameter.

8. The method for determining sag of an electricity transmission line based on image recognition according to claim 1, wherein the obtaining a sag expression of the catenary based on the complete catenary curve and the catenary curve equation and calculating a derivative of the sag expression to obtain a maximum sag comprises:
determining coordinates of two endpoints of the complete catenary curve, and constructing an equation of a straight line crossing the two endpoints;
obtaining the sag expression of the catenary as the equation of the straight line minus the catenary curve equation; and
calculating the derivative of the sag expression to obtain the maximum sag and a pixel coordinate corresponding to the maximum sag.

9. The method for determining sag of an electricity transmission line based on image recognition according to claim 1, further comprising:
calculating errors between coordinates of pixels obtained by the sage expression and coordinates of corresponding pixels in the image;
calculating an average error rate from the calculated errors; and
modifying the obtained maximum sag based on the average error rate.
